(19) United States
(12) Patent Application Publication
(10) Pub. No.: US 2016/0359304 A1
(43) Pub. Date: Dec. 8, 2016

(54) ELECTRICAL OUTLET WALL PLATE

(71) Applicant: Richard Troia, Deerfield Beach, FL (US)

(72) Inventor: Richard Troia, Deerfield Beach, FL (US)

(21) Appl. No.: 15/082,563

(22) Filed: Mar. 28, 2016

Related U.S. Application Data
(60) Provisional application No. 62/170,876, filed on Jun. 4, 2015.

(51) Int. Cl. H02G 3/08

(52) U.S. Cl. CPC H02G 3/081

(57) ABSTRACT

A wall plate for electrical outlets includes guide slots extending both vertically and horizontally on the front exposed face of the wall plate from the edges of the wall plate to one or more electrical outlets for guiding the blades of a two-prong or three-prong plug of an electrical cord into the socket openings of the electrical outlet. The wall plate is particularly useful in instances where the electrical outlet is hidden from view, such as behind an article of furniture or in dark or poor lighting conditions.

This non-provisional patent application is based on provisional patent application serial no. 62/170,876 filed on Jun. 4, 2015.

### BACKGROUND OF THE INVENTION

### Field of the Invention

The present invention relates to wall plates for electrical outlets and, more particularly, to a wall plate that helps to guide the blades of a electrical plug into the socket openings of an electrical outlet.

### Discussion of the Related Art

Inserting the blades of a two-prong (ungrounded) or three-prong (grounded) plug on an electrical cord into the correct socket openings of an electrical outlet is not always an easy task. For instance, if the lighting conditions are poor or the electrical outlet is located behind furniture (e.g., a couch, bed, nightstand, desk, etc.) it is very difficult, if not impossible, to see the socket openings. Typically, people will nervously reach and feel around the wall with their hand in attempt to locate the outlet plate and electrical sockets, and then hope to align the prongs of the plug with the correct socket openings of the outlet without being shocked by electricity. Eventually, many people will need to resort to use of a flashlight after their failed attempts of inserting the plug into the outlet.

In view of the longstanding and widespread problem of the inability to see electrical outlets when attempting to plug in an electrical device, as set forth above, there remains a definite need for a device that easily guides the blades of a two-prong or three-prong plug into the socket openings of the outlet, even when the outlet is hidden from view.

### BRIEF DESCRIPTION OF THE DRAWINGS

For a fuller understanding of the nature of the present invention, reference should be made to the following description taken in conjunction with the accompanying drawings in which:

FIG. 1 is a front elevational view showing the electrical outlet wall plate of the present invention fitted to an electrical outlet having two sockets, including an upper socket and a lower socket, and wherein the wall plate of the present invention is provided with a vertical arrangement of parallel guide slots extending from a top edge of the wall plate to the upper socket and from the bottom edge of the wall plate to the lower socket, and a horizontal arrangement of guide slots extending from the left and right side edges of the wall plate to the upper and lower sockets;

FIG. 2 is a front elevational view showing a first step in use of the electrical outlet wall plate of the present invention for plugging in a plug on an electrical cord into the upper socket of the outlet;

FIG. 3 is a top perspective view showing the next step in use of the wall plate of the present invention, wherein both blades of the plug are received in the corresponding guide slots on the wall plate for guiding movement of plug blades to the upper socket of the outlet;

FIG. 4 is a top perspective view showing the blades (i.e., prongs) of the plug received in the socket openings of the upper socket once having slid the prongs downwardly along the parallel guide slots and into the socket openings;

FIG. 5 is a top perspective view showing an alternative movement of the plug to the socket, wherein the blades of the plug are received in a horizontal guide slot extending from the left edge of the wall plate for guided sliding movement of the plug blades to the upper socket; and

FIG. 6 is a front elevational view showing the final step of operation of either the vertical or horizontal movement of the plug within the respective vertical or horizontal guide slots, wherein the plug is fully inserted into the outlet, with both blades of the plug fully inserted into the socket openings of the outlet.

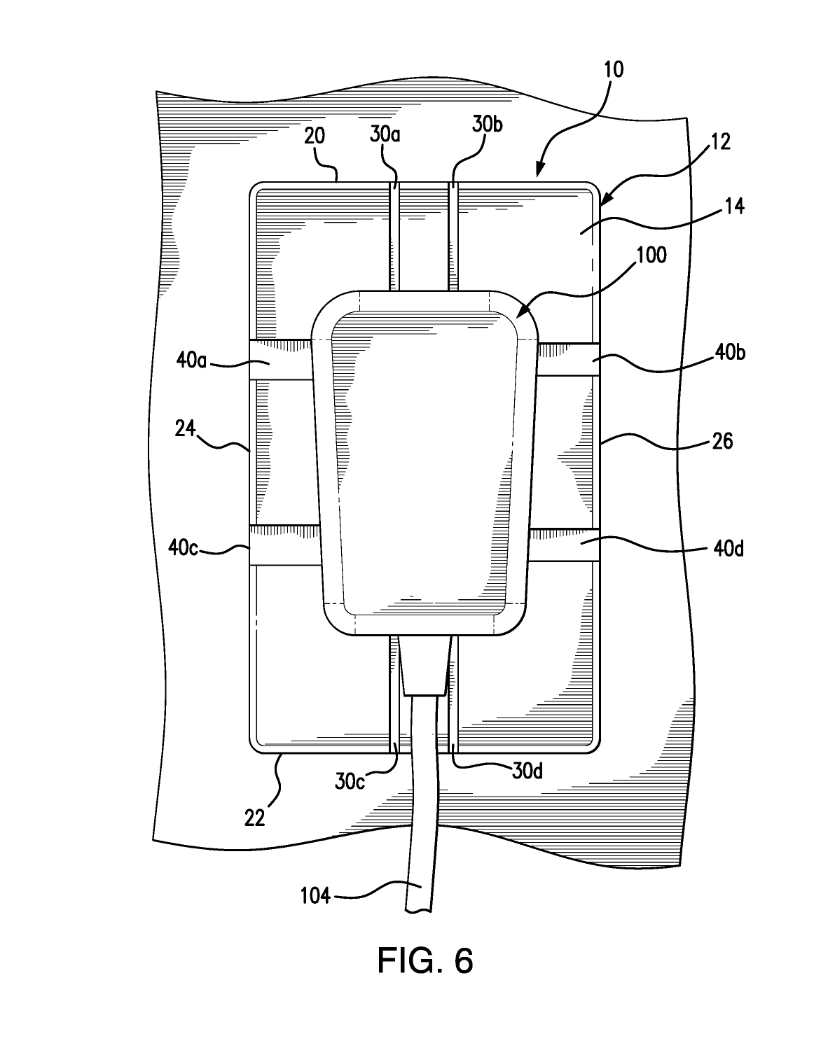

Description of the Invention

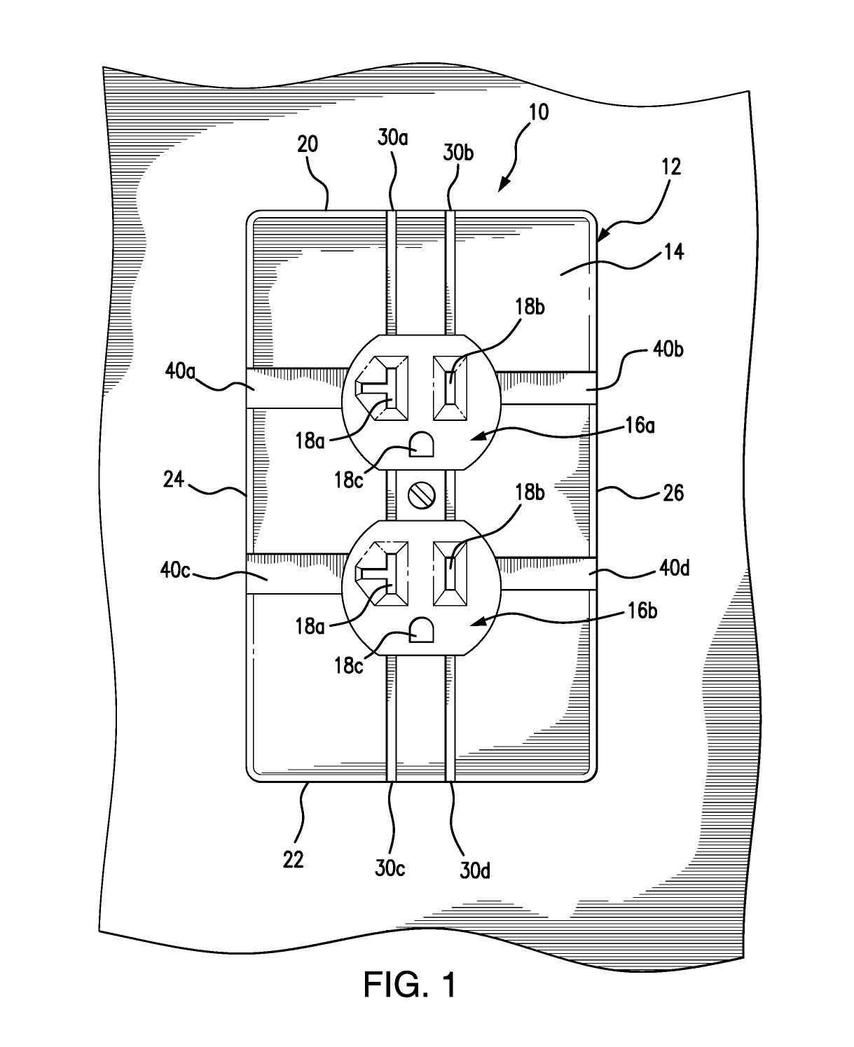

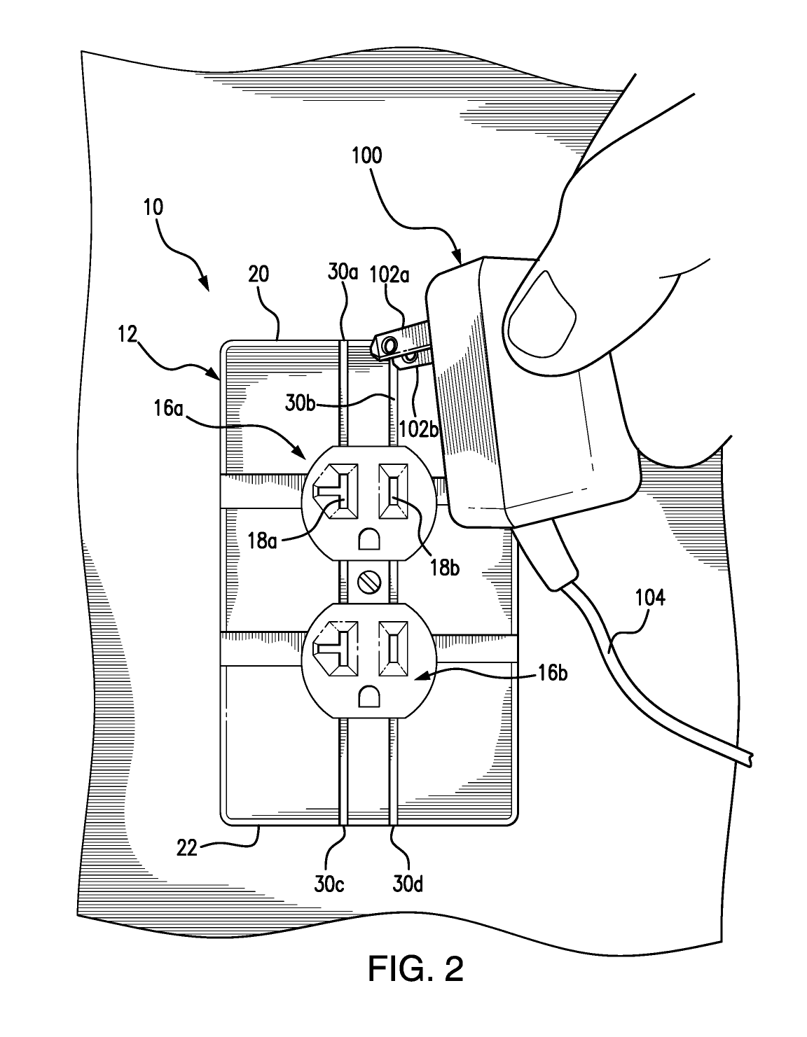

The present invention provides an electrical outlet assembly including a novel and extremely useful outlet cover plate 12 that replaces the well known wall outlet cover plate currently used for covering the outlet box opening and outlet fixture, while revealing the sockets of the electrical outlet fixture. A typical electrical outlet has either two or four sockets. In a two socket outlet, the sockets are arranged vertically with an upper socket 16a and a lower socket 16b, as shown in FIGS. 1-5. In a four socket outlet, there are two upper sockets (side by side) and two lower sockets (side by side). Conventional wall plates are designed with openings that receive the exposed faces of the sockets therein, when the wall plate is secured to the outlet. The present invention improves upon the conventional wall plate by providing a vertical arrangement of parallel guide slots 30a and 30b extending from the top edge 20 of the wall plate 12 to the upper socket(s) 16a and parallel guide slots 30c and 30d extending vertically from the bottom edge 22 of the wall plate 12 to the lower socket(s) 16b. Each pair of vertically oriented parallel guide slots 30a, 30b and 30c, 30d extends from the upper or lower edge of the wall plate, along the front exposed face of the wall plate, and to the respective upper or lower socket 16a, 16b. The parallel guide slots 30a, 30b, and 30c, 30d are in perfect vertical alignment with the socket openings 18a, 18b.

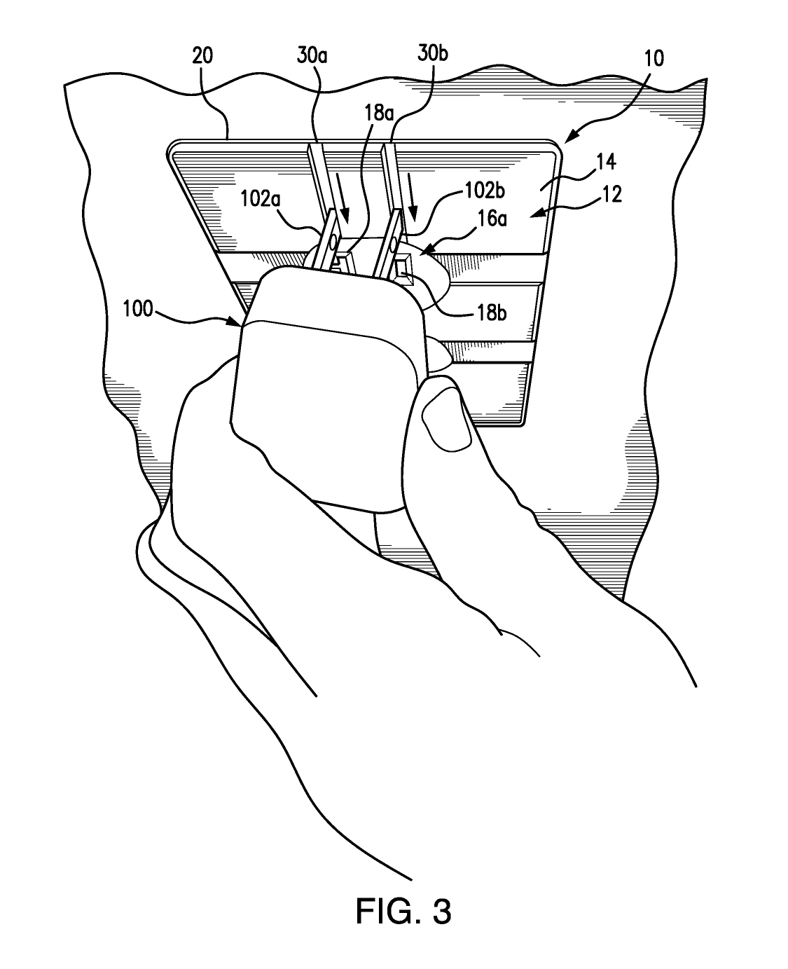

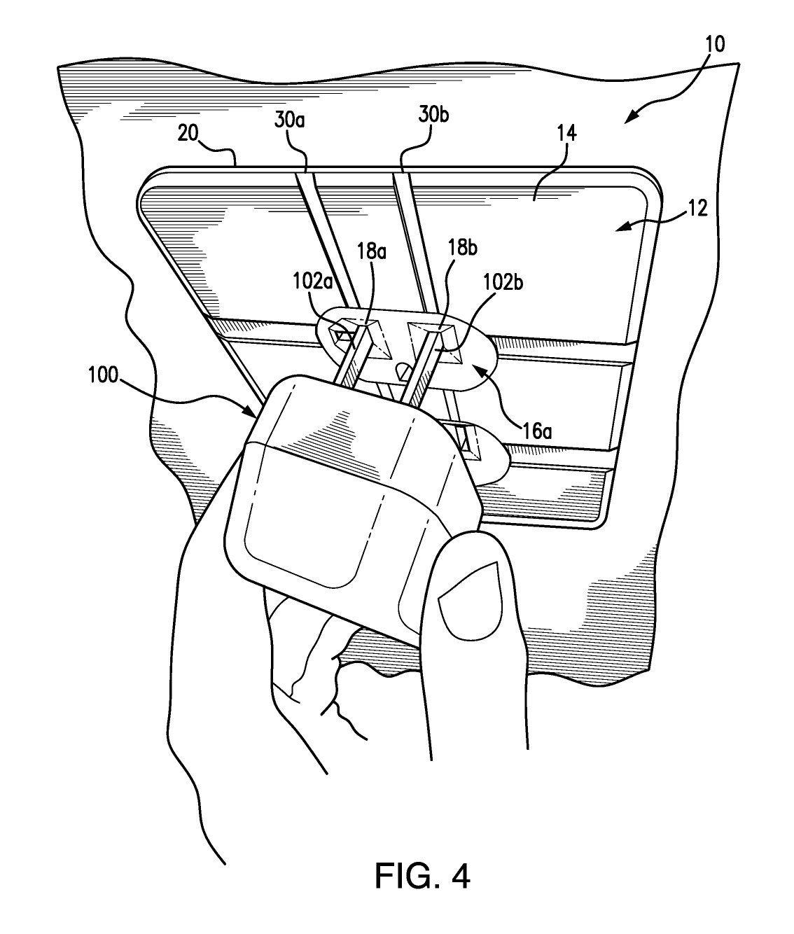

In use, the user desiring to plug an electrical device into the outlet simply holds the two-prong or three-prong plug 100 on the end of the electrical cord 104 of the device and contacts just the right blade 102b (i.e., prong) of the plug 100, for example, with the top right area of the face 14 of the wall plate 12 (or bottom right area if plugging into the lower socket) and then the user slides the blade 102b of the plug 100 to the left, while maintaining contact of the blade 102b with the outer surface of the wall plate, until the right blade 102b of the plug 100 drops into the right guide slot 30b on the wall plate 12. Next, the user turns the plug to move the left blade 102a into the left guide slot 30a on the wall plate so that both blades (i.e., prongs) of the plug 100 are in the respective parallel right and left guide slots 30a, 30b. The user can now move the plug 100 down the wall plate 12, as seen in FIG. 3, (or up if plugging into the lower socket) while keeping the blades 102a, 102b of the plug in the guide slots until the blades reach the socket 16a or 16b, at which point the blades 102a, 102b easily slide into the socket openings 18a, 18b, as shown in FIG. 4. Lastly, the plug 100 is pushed into the socket to fully insert the blades into the socket openings.

It should be noted that the same procedure can be performed by initially starting with the left blade 102a (i.e., prong) of the plug 100 and contacting the upper left area of the wall plate 12 (or lower left area if plugging into the lower socket) and then sliding the plug 100 to the right until the left blade 102a is received within the left guide slot 30a. The same steps, as described above, can then be performed to complete plugging the plug 100 into the socket of the outlet.

It should also be noted that the ends of the guide slots, along the top edge 20 and bottom edge 22 and the left and right side edges, can be flared to provide a larger entry opening of the guide slots along the edges of the wall plate to help direct the blades 102a, 102b (i.e., prongs) of the plug 100 into the guide slots when first directing of the wall plate.

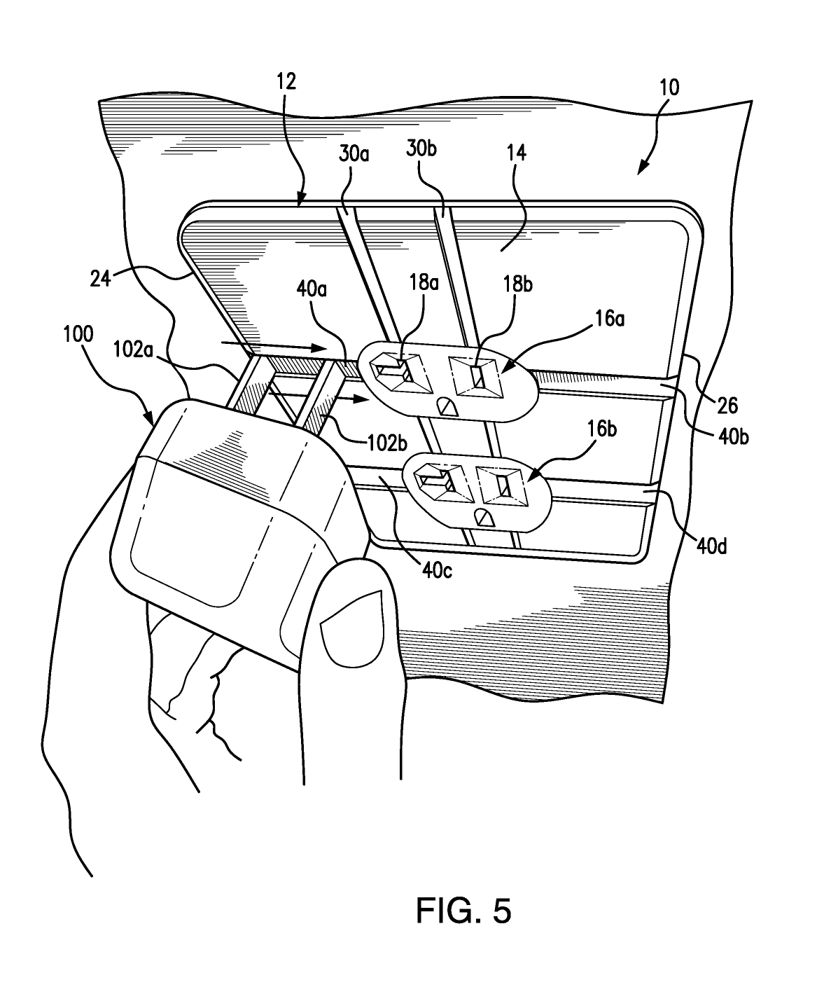

Referring to the several views of the drawings, the outlet cover plate 12 of the present invention may further include horizontal guide slots, including horizontal guide slots 40a and 40c extending from the left side edge 24 to the upper and lower sockets 16a and 16b, respectively, as well as horizontal guide slots 40b and 40d extending from the right side edge 26 to the upper and lower sockets 16a and 16b, respectively. As seen in FIG. 5, the horizontal guide slots 40a-40d are wider than the vertical guide slots 30a-30d, and each of the horizontal guide slots 40a-40d is structured and configured to receive both blades 102a and 102b of the plug 100 for sliding guided movement to the respective socket (16a or 16b ), as indicated by the arrows in FIG. 5. To use the horizontal guide slots, the user can simply place both blades of the plug against the face of the wall plate, and then move the blades up or down along the face of the wall plate until the blades of the plug are received within a respective one of the horizontal guide slots 40a-40d. Once within a horizontal guide slot, the user can then simply move the blades in the appropriate direction (either left or right) along the guide slot towards the center where the electrical socket is located. The blades of the plug will then be easily guided into the socket openings 18a and 18b of the electrical socket. Alternatively, the user can locate any one of the horizontal guide slots 40a-40d along a respective left or right side edge of the wall plate 12 and then place the blades 102a and 102b of the plug 100 within the particular horizontal guide slot for guided sliding movement towards the socket.

While the present invention has been shown and described in accordance with a preferred and practical embodiment, it is recognized that departures from the instant disclosure are fully contemplated within the spirit and scope of the present invention.

What is claimed is:

1. A wall plate for an electrical outlet having at least one electrical socket, said wall plate comprising:
a front face, a top edge, a bottom edge, a left side edge and a right side edge, and at least one central opening for receiving the at least one electrical socket therein when the wall plate is attached to the electrical outlet so that the at least one electrical socket is revealed and generally flush with the front face; and
a pair of parallel guide slots recessed within the front face of the wall plate and extending from at least one of either the top edge or the bottom edge and to the electrical socket, and the pair of parallel guide slots each being structured and disposed for receiving a respective one of two blades of a plug on an electrical cord and wherein the parallel guide slots allow for guided sliding movement of the two blades of the plug to the electrical socket with the two blades disposed in alignment with socket openings of the electrical socket for guided insertion therein.

2. The wall plate as recited in claim 1 wherein the pair of parallel guide slots extend from both the top edge and the bottom edge of the wall plate and vertically to the at least one electrical socket.

3. The wall plate as recited in claim 1 wherein the wall plate includes at least two central openings for receiving an upper electrical socket and a lower electrical socket of the electrical outlet.

4. The wall plate as recited in claim 3 wherein the pair of parallel guide slots include a first pair of parallel guide slots extending from the top edge of the wall plate to the upper electrical socket and a second pair of parallel guide slots extending from the bottom edge of the wall plate to the lower electrical socket when the wall plate is fitted to the electrical outlet with the upper and lower electrical sockets received in the respective central openings of the wall plate.

5. The wall plate as recited in claim 1 further comprising:
at least one horizontal guide slot recessed within the front face of the wall plate and extending from at least one of either the left side edge or the right side edge and to the electrical socket, and the at least one horizontal guide slot being structured and disposed for receiving the two blades of the plug therein, and the at least one horizontal guide slot allows for guided horizontal sliding movement of the two blades of the plug to the electrical socket for insertion within the socket openings.

6. The wall plate as recited in claim 5 including a pair of horizontal guide slots recessed within the front face of the wall plate and extending from both the left side edge and the right side edge of the wall plate and to the electrical socket.

7. The wall plate as recited in claim 3 further comprising:
a first pair of horizontal guide slots recessed within the front face of the wall plate and extending from the left side edge and the right side edge of the wall plate to the upper electrical socket, and a second pair of horizontal guide slots recessed within the front face of the wall plate and extending from the left side edge and the right side edge of the wall plate and to the lower electrical socket.
